(19) United States
(12) Patent Application Publication
(10) Pub. No.: US 2017/0330228 A1
(43) Pub. Date: Nov. 16, 2017

(54) SERVICE METHOD FOR PROVIDING GAME PLAY VIDEO BY ADDITIONALLY APPLYING ADVERTISEMENT CONTENT THERETO

(71) Applicant: MINKONET CORPORATION, SEOUL (KR)

(72) Inventors: TAE WOO KIM, GYEONGGI-DO (KR); DONG HWAL LEE, SEOUL (KR)

(73) Assignee: MINKONET CORPORATION, SEOUL (KR)

(21) Appl. No.: 15/667,630

(22) Filed: Aug. 3, 2017

Related U.S. Application Data
(63) Continuation-in-part of application No. PCT/KR2016/000905, filed on Jan. 28, 2016.

(30) Foreign Application Priority Data
Feb. 4, 2015 (KR) 10-2015-0017590

(51) Int. Cl. G06Q 30/02; A63F 13/335; G06Q 30/06; H04N 21/4725

(52) U.S. Cl. CPC G06Q 30/0251; H04N 21/4725; A63F 13/335; G06Q 30/0625; A63F 2300/208

(57) ABSTRACT

Provided is a service method of providing a game play video by additionally applying advertisement content to the game play video, and more particularly, to a service method of providing a game play video by additionally applying advertisement content to the game play video, whereby advertising effects are spontaneously obtained while a user is viewing a game video by adding an advertisement to the video showing a game played by game users. According to the service method of providing a game play video by additionally applying an advertisement content to the game play video, a data capacity of a game video may be remarkably reduced and a high image quality may be maintained, and high advertising effects may be achieved without interfering with the user's viewing of the game video.

### CROSS REFERENCE TO RELATED APPLICATIONS

This application is a Continuation of PCT International Application No. PCT/KR2016/000905, filed on Jan. 28, 2016, which claims priority under 35 U.S.C. §119(a) to Patent Application No. 10-2015-0017590, filed in Korea on Feb. 4, 2015, all of that are hereby expressly incorporated by reference into the present application.

### BACKGROUND OF THE INVENTION

### Field of the Invention

The inventive concept relates to a service method of providing a game play video by additionally applying advertisement content to the game play video, and more particularly, to a service method of providing a game play video by additionally applying advertisement content to the game play video, whereby advertising effects are spontaneously obtained while a user is viewing a game video by adding an advertisement to the video showing a game played by game users.

### Description of Related Art

Recently, video service systems such as YouTube have enabled users to view and replay videos in various fields. In addition, as smartphones and tablets have become popular, the number of games that can be enjoyed not only on personal computers and game terminals but also on mobile devices is increasing, and more and more users play these games. As a result, the number of users who enjoy a game by uploading their gameplay videos to video services or by watching videos uploaded by other users is increasing.

On the part of server operators providing these game play videos, there are various difficulties in receiving, storing, and transmitting videos having a relatively large data capacity.

In addition, it is also inconvenient for a user, who records and uploads a game video to a script server, to capture, in real time, an image displayed on a screen of a terminal on which a game is played, and store the captured image as a video file which is a set of consecutive image frames. This method according to the related art often imposes a heavy load on a computing device of a user terminal, frequently interfering with a game play by, for example, interrupting the game or decreasing a game play speed. According to some of the techniques according to the related art, a video is recorded by intentionally lowering an image quality of the video in order to reduce the load on a computing device of a user terminal. Also, if an image is recorded on a terminal having a low resolution and replayed on another terminal, the image quality may be lowered and the interest of the user may be decreased.

Meanwhile, server operators have difficulty in creating advertisement revenues by additionally applying advertisement to collected game videos. Conventionally, a typical method is to provide an advertisement image for a certain period of time before a start of a video, or to add an advertisement banner to the bottom part of a screen of a video while providing a game video by using a streaming method. This method may make the user lose interest in watching the game video and interfere with watching the game video.

### SUMMARY OF THE INVENTION

The inventive concept provides a service method of providing a game play video by additionally applying an advertisement content to the game play video, whereby a data capacity of a game video may be remarkably reduced and a high image quality may be maintained, and high advertising effects may be achieved without interfering with the user's viewing of the game video.

According to an aspect of the inventive concept, there is provided a service method of providing a game play video by additionally applying an advertisement content to the game play video, the service method including: (a) configuring an original script list by storing script information in a storage unit of a script server, wherein the script information records data on the appearance an exit points of time of a character, props, and a background included in object information, and data on movements of the character, props, and background according to time so as to render a game play video based on the object information including three-dimensional shape information (object) of the character, the props, and the background that constitute a game; (b) configuring an advertisement script list by storing script information of an advertisement video, which is formed by adding an advertisement object displaying an advertisement to the script information of each video of the original script list, and the advertisement object used in the advertisement video, wherein the storing is performed by the script server; (c) providing the user terminal with the advertisement script list according to a request by a user terminal which replays a game play video by using the script information and the advertisement object, wherein the providing is performed by the script server; and (d) upon receiving a request by the user terminal for selecting one of advertisement videos included in the advertisement script list, transmitting script information of the advertisement video selected by the user terminal and the advertisement object used in the script information to the user terminal, wherein the transmitting is performed by the script server.

According to the service method of providing a game play video by additionally applying an advertisement content to the game play video of the inventive concept, a game play video having a small data capacity may be provided with a high image quality.

According to the service method of providing a game play video by additionally applying an advertisement content to the game play video, an advertisement may be inserted into the game play video in various manners, and also, high advertising effects may be obtained as the interest of users in the game play video is not decreased.

### BRIEF DESCRIPTION OF DRAWINGS

FIG. 1 is a flowchart of a service method of providing a game play video by additionally applying advertisement content to the game play video, according to an embodiment of the inventive concept; and

FIG. 2 through FIG. 4 show a replay screen of a video for explaining an operation of a service method of providing a game play video by additionally applying an advertisement content to the game play video described with reference to FIG. 1.

### DESCRIPTION OF THE EMBODIMENTS

Hereinafter, a service method of providing a game play video by additionally applying an advertisement content to the game play video according to the inventive concept, will be described more fully with reference to the accompanying drawings.

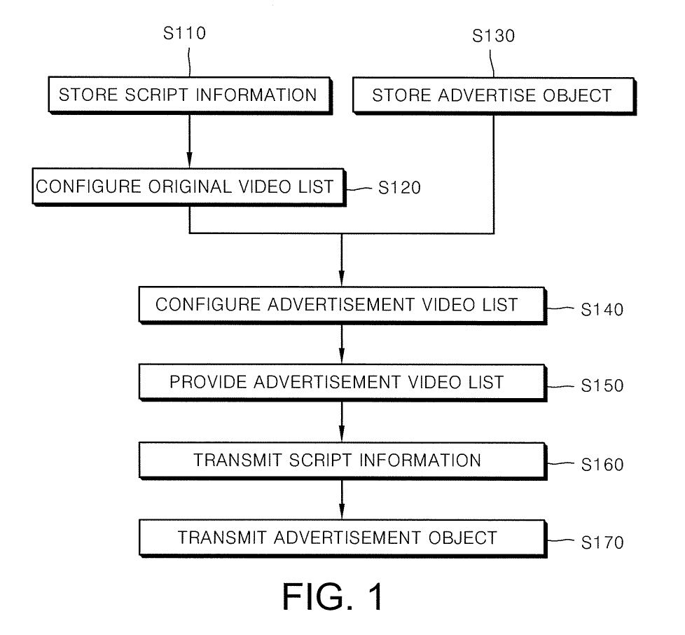

FIG. 1 is a flowchart of a service method of providing a game play video by additionally applying an advertisement content to the game play video, according to an embodiment of the inventive concept.

The service method of providing a game play video by additionally applying an advertisement content to the game play video according to the present embodiment is performed on a script server in which a game video is stored. Users may receive a video which is in the foul′ of script information to be described later, from the script server on a user terminal (e.g., smartphone, a personal computer, or a tablet) and replay the video. The user terminal may be a device with which a user plays a game or a simply game video replayer via which script information is received to replay a game video.

A game which is an object of a game video provided according to the service method of providing a game play video by additionally applying an advertisement content to the game play video according to the present embodiment is a game operated based on object information and script information. Object information is three-dimensional shape information of characters, props and backgrounds that constitute a game. Object information is typically provided as three-dimensional mesh-type data through a game developing tool. When a user installs a game on a user terminal, object information used in the game is automatically stored on the user terminal. Script information includes data on the appearance and exit points of time of characters, props and backgrounds included in the object information as well as their movements according to time (movement is a concept encompassing motion, transformation, travel, changes in angles or the like of objects). Script information refers to numerically expressed data of changes according to time in objects' (characters, props, backgrounds) positions, angles and motions in virtual space where the game is played. Each game object is deployed in a static state or moved based on the script information.

In the case of games operated by using object information and script information, if necessary object information is already stored in a user terminal, a game video may be replayed based only on script information. That is, without the need for a user to record a game play video entirely in units of image frames, just when a user terminal records and stores real-time script information, the user terminal may replay a game video by linking script information and object information to each other and render them.

Hereinafter, a process of providing a video including an advertisement, to a user of a user terminal via a script server, by using object information and script information as described above, will be described with reference to FIG. 1.

First, a step in which a script server configures an original script list by storing videos of diverse game play situations, in a storage unit of the script server is performed (step (a); S120). The videos stored in step (a) are not stored by compression of each image frame but are in the form of script information used to display a video on a screen by being linked to object information. This type of video may be stored by a server operator or may be transmitted by a user of a user terminal to a script server and stored by the script server. According to the inventive concept, as a video is provided to a user terminal in the form of script information, object information does not have to be necessarily stored on the script server. However, to prepare for a case where a user wants to view a video by receiving script information stored in the script server while object information is not stored on a user terminal, object information may be stored on the script server. In addition to the case of providing a video in the form of script information by the script server, if a conventional method of providing a video by a streaming method, it is preferable that object information is also stored in the script server. In this case, the object information and the script information may be rendered in real time from the script server and transmitted to a user terminal via a streaming method.

Script information of each game play image constituting the original script list may be received by the script server via an input by an operator of the script server and stored in a storage unit of the script server, or the script server may receive a video in the form of script information stored by a user enjoying a game, in a user terminal of the user, and store the video in a storage unit. Hereinafter, an example in which a script server configures an original video by using script information transmitted by a user to the script server by using a user terminal will be described with reference to FIG. 1.

First, while a user is playing a game by using a user terminal, script information of the game being played is stored by the user terminal. A tool for storing the script information is provided by a game developer by adding the tool as a menu in the game. Just by pressing a recording button displayed on a game screen while the user is playing the game, the user terminal may collect and store the script information. According to circumstances, a game program of the user terminal may automatically collect and store script information of critical situations.

When a video of a game being played in real time is recorded by collecting image frames, a load is imposed on an operation of a user terminal (particularly, a terminal such as a mobile device), and thus the game play may be interrupted or images may become unnatural. However, an operation of storing script information, which is a set of simple numerical data as in the present embodiment, requires a relatively small data capacity and does not affect the game play significantly.

As described above, a video recorded in the form of script information may be directly transmitted to the script server, but also, a user terminal may transmit script information edited by a user according to necessity.

Editing of a video on a user terminal may be performed by modifying script information. A user may edit a video by installing a replay editor for editing script information on the user terminal. The replay editor allows to modify an object included in a video or replace an object with another object. In addition, by using the replay editor, the color or texture of an object may be modified.

Even more various video editing is possible if script information includes filming information for setting a location, movement and a zoom level of a camera placed in virtual space where a video is realized. When editing filming information, more dramatic and diverse videos can be created compared to those displayed on a user terminal during a user's game play. For instance, if editing is performed to modify a camera location, a replay video that is filmed from a different angle from a video recorded during a game play may be realized with respect to the same situation. According to a user command, the replay editor may edit script information a video filmed by moving a camera along a particular route (like a video that is shot by a cameraman carrying a camera and moving to shoot the video) or such that a video, which was previously filmed from the front during a game play, is modified to a video that is filmed from above. In addition, a video determined by a user to be of an important situation may be zoomed in to be enlarged or a replay speed of the video may be adjusted to replay the same as a slow video. These various editing is possible because a video is recorded and transmitted basically in the form of script information according to the inventive concept.

When video editing is completed as described above, the user terminal transmits the script information of the game play video to the script server according to a user command.

When the user terminal stores and transmits a video of a game play played by the user by using the user terminal, in the form of script information, the script server receives the script information and stores the same (step (e); S110). The user terminal does not store and transmit a video file of a large capacity as in the related art but stores and transmits only script information which has a remarkably less capacity. Consequently, it is easy to record a game video, and its data capacity is small. In addition, as the user terminal transmits a game video in the form of script information to the script server, the user terminal may also transmit the video to the script server more easily and quickly.

The script server stores the script info illation received from the user terminal in the storage unit and configures an original script list by using the script information in step (a) described above (S120).

As the script server stores the script information (video) that is edited by the user to be more dramatic and configures an original script list based on the script information as described above, a video viewing rate of users may be increased.

When the original script list is configured in the server as described above, next, a step in which the script server configures an advertisement script list by editing script information of an original video and adding an advertisement to the script information is performed (step (b); S140). The script server provides an advertisement to be displayed on a game video in the form of an object and stores the advertisement in the storage unit (S130). The script information is edited such that the advertisement object is added to the game video, thereby generating script information of an advertisement video. In this manner, the script server converts the original script list generated in step (a) into an advertisement script list (S140). A method of generating an advertisement video by editing script information may be modified in various manners. The script server may edit the script information such that advertisement objects such as a banner, a billboard or an ad balloon bearing an advertisement copy appears in the video. The script server may also edit the script information such that an advertisement is displayed on a surface of an object by modifying a texture of the object such as a background wall, costumes of characters or the trim of automobiles that are previously present in the original video.

An operation of editing a script of an advertisement video by editing a script of an original video as described above may be performed in various manners. An operator of a script server may perform an operation of editing a script of an original video altogether and the script server may receive the advertisement script and store the same in a storage unit to thereby configure an advertisement script list. Alternatively, an advertisement video may be generated as the script server edits a script of an original video according to a previously set standard and order. That is, the script server may first store a list of advertisement objects that may be included in an advertisement video (advertisement object list) (step (f); S130), and then the script server may add script information of an advertisement object selected from the advertisement object list to each piece of script information of the original script list to thereby configure an advertisement script list.

When the advertisement script list is configured as described above, the user may check the advertisement script list of the script server by accessing the script server by using the user terminal. When a user terminal, which is capable of linking available linking script information and available advertisement objects of an advertisement video to each other to render a game play video, requests an advertisement script list, the script server provides the advertisement script list to the user terminal (step (c); S150).

The user check the advertisement script list by accessing the script server via the user terminal, and selects an advertisement video that the user wishes to view. When a selection request by the user for a particular advertisement video is transmitted to the script server via the user terminal, the script server transmits script information of the advertisement video selected by the user terminal and an advertisement object used in the script information, to the user terminal (step (d); S170).

When the user terminal receives from the script server the script information and the advertisement object of the advertisement video, the script information and the object information and the advertisement object may be linked to one another to render a video. The user may easily replay and view a video of a high image quality just by the fact that the user terminal receives data of a relatively small capacity, from the script server.

While the user installs a game on the user terminal, object information used in the game is stored on the user terminal, and thus, just by using script information, the user terminal may render a video by using previously stored object information. The advertisement object is added via the script server, and thus, the user terminal may receive the advertisement object from the script server and encode the same with the script information so as to replay a video, to which an advertisement is added.

When replaying a video on the user terminal, an optimum video may be rendered by considering a resolution and a screen size of the user terminal, and performance of a computing device of the user terminal, and thus, according to the inventive concept, a satisfaction level of users regarding viewing of a video may be improved. According to the inventive concept, as the user terminal renders each time a new video that suits the performance of the user terminal, a video with an optimum image quality may be replayed under performance conditions of the user terminal. According to circumstances, the user terminal may replay a game play video of a higher image quality than that of an image displayed on a screen during the user's game play.

According to the related art, video files of various resolutions are prepared on a script server and a video of a resolution selected by a user is transmitted using a streaming method. However, according to the inventive concept, a user terminal adequately renders a video according to a given situation just based on script information. Accordingly, a video transmission speed is high, and the video may be rendered at a most appropriate resolution for the user terminal.

A video used in the service method of providing a game play video by additionally applying an advertisement content to the game play video according to the inventive concept as described above is configured based on object information and script information, and thus, it is very easy to edit the video. Script information about various types of objects such as an advertisement pillar, a banner, an electronic display board or an ad balloon, may be added to previously stored script information, and also, editing the script information such that an advertisement image is printed as a texture on a surface of an object that is already written to appear, in the script information. In the case of the conventional video service using a streaming method, only an advertising method such as adding a planar banner to a video was possible. However, according to the present embodiment, an advertisement may be added even to an object of a video, and the advertisement may be easily changed to other various advertisements according to circumstances. Thus, advertising effects may be enhanced without significantly interfering with a user viewing the video.

Meanwhile, if a game is not installed on a user terminal, then not only an advertisement object but also information about other objects may not be stored on the user terminal. If no object information is stored on the user terminal, a video replay is possible only when object information used in script information is also transmitted when the script sever transmits the script information. For this case, when configuring a script list in step (a) described above, not only script information but object information used in a video may also be stored in the storage unit of the script server to configure the script list. In this case, when the script server transmits script information and an advertisement object to the user terminal according to the user terminal's request in step (d), the object information configured in the script list is also transmitted to the user terminal. The user terminal may replay a video by receiving object information from the script server by using the above-described method also when previously stored object information is not available.

As described above, according to the service method of providing a game play video by additionally applying advertisement content to the game play video of the inventive concept as described above, various advertisement objects may be input by editing script information, and thus, more effective advertising may be conducted.

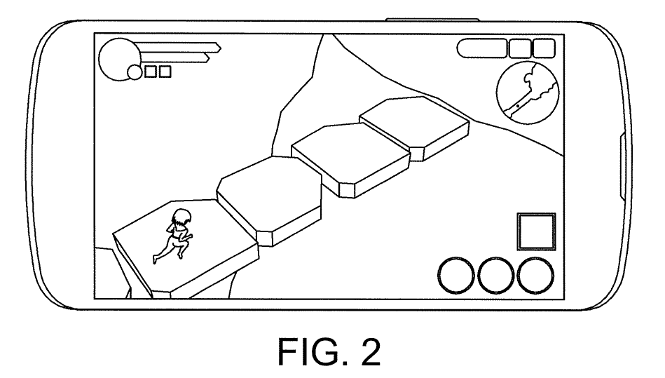

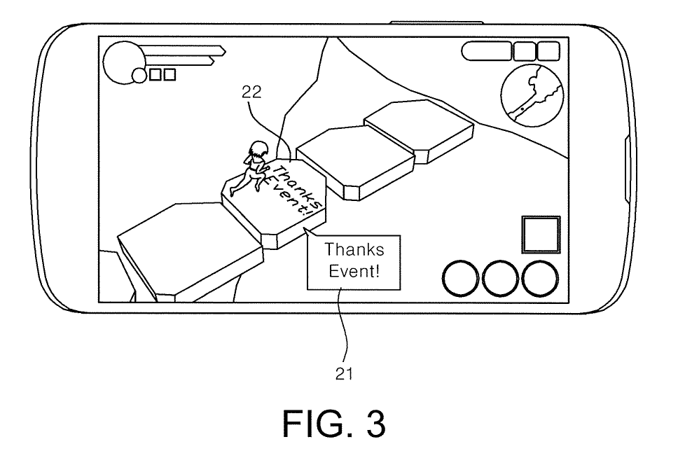

For example, script information may be edited such that an advertisement object appears when one of objects of an advertisement video is located at a particular point in three-dimensional space. That is, script information may be edited such that an advertisement object appears on a screen if a game character stands at a particular point. FIG. 2 illustrates a state where a game character is just about to reach a particular point. Here, a typical game video is displayed on a screen of a user terminal. As illustrated in FIG. 3, when a game character reaches a preset point in an advertisement video, advertisement objects 21 and 22 are displayed on the floor surface on which the character stands and at a lower end of the screen. By adding a link of a web address of a website via which a product advertised can be purchased, to the advertisement objects 21 and 22, the user may touch the advertisement and immediately purchase the product.

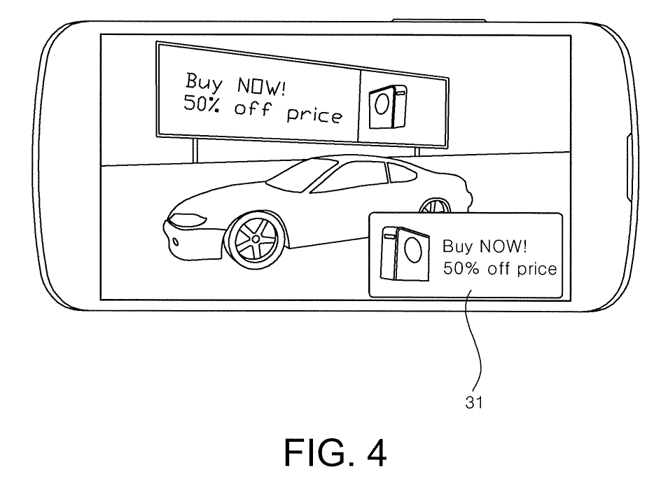

In the case of a car driving game as illustrated in FIG. 4, an advertisement 31 may be set to be displayed on a screen when a car reaches coordinates set in script information. By displaying an advertisement on the screen in this manner, a rate that users recognize an advertisement may be improved.

Meanwhile, when script information is configured by editing filming information as described above, even more diverse visual effects may be realized in an advertisement video. Advertisement objects may be enlarged by zooming in when an advertisement is exposed, or a camera may be moved to expose an advertisement object on a screen with a more dynamic screen from various angles.

While the inventive concept has been particularly shown and described with reference to exemplary embodiments thereof, the scope of the inventive concept is not limited to the forms described and illustrated above.

While the example in which an advertisement object appears on the screen when a game character reaches a particular point is described above, other various methods may also possible. For example, an advertisement video may be configured such that a product advertised falls from the sky along a line along which a game character moves, or a game video may be configured such that an advertisement changes on an outer surface of a driving car.

What is claimed is:

1. A service method of providing an advertising service by using a game play video by additionally applying an advertisement content to the game play video, the service method comprising:
(a) configuring an original script list by storing script information in a storage unit of a script server, wherein the script information records data on the appearance an exit points of time of a character, props, and a background included in object information, and data on movements of the character, props, and background according to time so as to render a game play video based on the object information including three-dimensional shape information (object) of the character, the props, and the background that constitute a game;
(b) configuring an advertisement script list by storing script information of an advertisement video, which is formed by adding an advertisement object displaying an advertisement to the script information of each video of the original script list, and the advertisement object used in the advertisement video, wherein the storing is performed by the script server;
(c) providing the user terminal with the advertisement script list according to a request by a user terminal which replays a game play video by using the script information and the advertisement object, wherein the providing is performed by the script server; and
(d) upon receiving a request by the user terminal for selecting one of advertisement videos included in the advertisement script list, transmitting script information of the advertisement video selected by the user terminal and the advertisement object used in the script information to the user terminal, wherein the transmitting is performed by the script server.

2. The service method of claim 1, wherein in (a), an object information used in each video of the original script list is also stored in the storage unit of the script server by the script server to configure the original script list,
wherein in (d), if object information used in script information of an advertisement video transmitted by the script server to the user terminal is not stored on the user terminal, the object information is also transmitted to the user terminal.

3. The service method of claim 2, wherein in (b), the script server configures an advertisement script list including script information that is edited such that the advertisement object appears when an object of the advertisement video is located at a particular point in three-dimensional space, and stores the advertisement script list in the storage unit of the script server.

4. The service method of claim 3, wherein the script information further comprises filming information, based on which a location and a movement of a camera for filming the objects appearing and moving based on the script information, a zoom level of the camera, and a replay speed are set,
wherein in (b), the script server configures the advertisement script list based on the script information including edited filming information.

5. The service method of claim 2, further comprising (e) receiving a game play video stored in the user terminal in the form of script information, from the user terminal, and storing the game play video in the storage unit, wherein the receiving and the storing are performed by the script server,
wherein in (a), the script server configures an original script list by using the script information received in (e).

6. The service method of claim 2, further comprising (f) storing a list of advertisement objects that may be included in the advertisement video (advertisement object list) in the storage unit, wherein the storing is performed by the script server,
wherein in (b), the script server adds an advertisement object selected from the advertisement object list stored in the script server, to each piece of script information of the original script list so as to configure the advertisement script list.

7. The service method of claim 1, wherein in (b), the script server configures an advertisement script list including script information that is edited such that the advertisement object appears when an object of the advertisement video is located at a particular point in three-dimensional space, and stores the advertisement script list in the storage unit of the script server.

8. The service method of claim 7, wherein the script information further comprises filming information, based on which a location and a movement of a camera for filming the objects appearing and moving based on the script information, a zoom level of the camera, and a replay speed are set,
wherein in (b), the script server configures the advertisement script list based on the script information including edited filming information.

9. The service method of claim 1, wherein the advertisement object of the advertisement video stored in the script server in (b) comprises a link of a web address of a website via which purchase of a product advertised is possible.

10. The service method of claim 1, further comprising (e) receiving a game play video stored in the user terminal in the form of script information, from the user terminal, and storing the game play video in the storage unit, wherein the receiving and the storing are performed by the script server,
wherein in (a), the script server configures an original script list by using the script information received in (e).

11. The service method of claim 1, further comprising (f) storing a list of advertisement objects that may be included in the advertisement video (advertisement object list) in the storage unit, wherein the storing is performed by the script server,
wherein in (b), the script server adds an advertisement object selected from the advertisement object list stored in the script server, to each piece of script information of the original script list so as to configure the advertisement script list.
